(19) United States
(12) Patent Application Publication
(10) Pub. No.: US 2015/0065496 A1
(43) Pub. Date: Mar. 5, 2015

(54) PESTICIDAL COMPOSITIONS COMPRISING BENZOYLUREA COMPOUND AND FURTHER PESTICIDAL COMPOUND AND THEIR USES

(71) Applicant: BASF SE, Ludwigshafen (DE)

(72) Inventor: Markus Gewehr, Kastellaun (DE)

(21) Appl. No.: 14/396,931

(22) PCT Filed: Apr. 23, 2013
(86) PCT No.: PCT/IB2013/053195

§ 371 Date: Oct. 24, 2014

Related U.S. Application Data
(60) Provisional application No. 61/639,115, filed on Apr. 27, 2012.

(30) Foreign Application Priority Data
Apr. 27, 2012 (EP) 12165989.0

(51) Int. Cl. A01N 43/88; A01N 43/56; A01N 47/34

(52) U.S. Cl. CPC A01N 43/88; A01N 47/34; A01N 43/56
USPC 514/229.2

(57) ABSTRACT

The present invention relates to Pesticidal compositions comprising a benzoylurea compound (I) being flufenoxuron or teflubenzuron and further pesticidal compounds (II) and optionally compounds (III) in synergistically effective amounts.

The invention also relates to the use of said compositions for controlling, combating invertebrate pests. The invention further relates to methods of applying such compositions.

The invention relates to a pesticidal composition comprising an insecticidal benzoylurea compound (I) from the group of inhibitors of the chitin synthesis and one insecticidal compound (II) from the group of nicotinic acetylcholine receptors agonist as defined hereinafter and the use of such composition for controlling invertebrate pests.

In spite of the commercial insecticides, acaricides and nematicides available today, damage to crops, both growing and harvested, caused by insects, arachnids and nematodes still occur. Therefore, there is a continuing need to develop new insecticidal, acaricidal and nematicidal agents.

One typical problem arising in the field of pest control lies in the need to reduce the dosage rates of the active ingredient in order to reduce or avoid unfavourable environmental or toxicological effects whilst still allowing effective pest control. Another problem encountered concerns the need to have available pest control agents which are highly effective against a broad spectrum of pests. There also exists the need for pest control agents that combine know-how activity with prolonged control, that is, fast action with long lasting action. Another difficulty in relation to the use of pesticides is that the repeated and exclusive application of an individual pesticidal compound leads in many cases to a rapid selection of pests which have developed natural or adapted resistance against the active compound in question. Therefore there is a need for pest control agents that help prevent or overcome those problems.

It was therefore an object of the present invention to provide new pesticidal agents and new methods which solve the above evoked problems for the control of invertebrate pests including insects, arachnids or nematodes and of protecting growing plants from attack or infestation by insects, arachnids or nematodes. It was also an object to provide new methods for the control of invertebrate pests.

The benzoylurea compounds (I) are for example known from U.S. Pat. No. 5,874,615 or EP 0161019 as well as their pesticidal activity. U.S. Pat. No. 4,698,365 and U.S. Pat. No. 4,623,658 disclose benzoylurea compounds having pesticidal activities, particularly insecticidal and acaricidal properties. Further benzoylurea compounds according to the invention and their method of use are known from U.S. Pat. No. 4,457,943. JP 63126804 and U.S. Pat. No. 4,666,942 disclose methods of uses of benzoylurea compounds as insecticidal and compositions comprising the benzoylurea in combination with other compounds having pesticidal properties particularly insecticides of the order of organophosphates and pyrethroids.

The need of an efficient composition having effective and high insecticidal activity is still desirable in order to combat harmful insects which can cause a great damage to crops and other plants and solve the problems above mentioned.

We have found that these objects in part or in whole are achieved by the combination of active compounds (I) and (II) as defined in the present invention. Moreover, we have found that simultaneous, that is jointly or separate, application of active compound (I) and compound (II) or successive application of compounds (I) and (II) allows enhanced control of pests compared to the control rates that are possible with the individual compounds.

Therefore, it has now been surprisingly found that, mixing a benzoylurea compound (I) being flufenoxuron or teflubenzuron with at least one insecticidal compound (II) selected from the group of nicotinic acetylcholine receptors agonist consisting of clothianidin, cycloxaprid, nitenpyram, thiacloprid and 1-[(6-chloro-3-pyridyl)methyl]-7-methyl-8-nitro-5-propoxy-3,5,6,7-tetrahydro-2H-imidazo[1,2-a]pyridine, achieved the objects of the present invention at least in certain aspects.

Accordingly, one aspect of the invention is the provision of a pesticidal composition comprising as active components,
1) a benzoylurea compound (I) from the group of inhibitors of the chitin synthesis being flufenoxuron or teflubenzuron and
2) at least one insecticidal compound (II) selected from the group of nicotinic acetylcholine receptors agonist consisting of acetamiprid, clothianidin, cycloxaprid, imidacloprid, nitenpyram, thiacloprid, thiamethoxam and 1-[(6-chloro-3-pyridyl)methyl]-7-methyl-8-nitro-5-propoxy-3,5,6,7-tetrahydro-2H-imidazo[1,2-a]pyridine, and
3) optionally a compound (III) selected from the group of compounds
   IIIA: azoxystrobin, dimoxystrobin, fluoxastrobin, kresoxim-methyl, picoxystrobin, pyraclostrobin, trifloxystrobin, and pyribencarb;
   IIIB: bixafen, boscalid, and fluxapyroxad;
in synergistically effective amounts; with the proviso that, for the combinations of
a) teflubenzuron and imidacloprid,
b) teflubenzuron and thiamethoxam,
c) teflubenzuron and acetamiprid,
d) flufenoxuron and thiamethoxam,
e) flufenoxuron and acetamiprid,
at least one additional compound (III) is present; wherein the ratio by weight of compound (I) and (II) is from 500:1 to 1:500, preferably from 100:1 to 1:100 more preferably from 50:1 to 1:50, most preferably from 20:1 to 1:20, and utmost preferred from 10:1 to 1:10; and the weight ratio of compounds (II) to (III) is from 100:1 to 1:100 more preferably from 50:1 to 1:50, most preferably from 20:1 to 1:20, and utmost preferred from 10:1 to 1:10; and the weight ratio of compounds (I) to (III) is from 100:1 to 1:100 more preferably from 50:1 to 1:50, most preferably from 20:1 to 1:20, and utmost preferred from 10:1 to 1:10

Another aspect of the invention is the provision of a pesticidal composition comprising as active components,
1) a benzoylurea compound (I) from the group of inhibitors of the chitin synthesis being flufenoxuron or teflubenzuron and
2) at least one insecticidal compound (II) selected from the group of nicotinic acetylcholine receptors agonist consisting of clothianidin, cycloxaprid, nitenpyram, thiacloprid and 1-[(6-chloro-3-pyridyl)methyl]-7-methyl-8-nitro-5-propoxy-3,5,6,7-tetrahydro-2H-imidazo[1,2-a]pyridine;
   in synergistically effective amounts, wherein the ratio by weight of compound (I) and (II) is from 500:1 to 1:500, preferably from 100:1 to 1:100 more preferably from 50:1 to 1:50, most preferably from 20:1 to 1:20, and utmost preferred from 10:1 to 1:10.

A further aspect of the invention is the provision of a pesticidal composition comprising as active components,
1) a benzoylurea compound (I) from the group of inhibitors of the chitin synthesis being flufenoxuron or teflubenzuron and
2) at least one insecticidal compound (II) selected from the group of nicotinic acetylcholine receptors agonist consisting of acetamiprid, clothianidin, cycloxaprid, imidacloprid, nitenpyram, thiacloprid, thiamethoxam and 1-[(6-chloro-3-pyridyl)methyl]-7-methyl-8-nitro-5-propoxy-3,5,6,7-tetrahydro-2H-imidazo[1,2-a]pyridine and
3) one or two compound (III) selected from the group of compounds
   IIIA: azoxystrobin, dimoxystrobin, fluoxastrobin, kresoxim-methyl, picoxystrobin, pyraclostrobin, trifloxystrobin, and pyribencarb; and/or
   IIIB: bixafen, boscalid and fluxapyroxad;
in synergistically effective amounts; wherein the ratio by weight of compound (I) and (II) is from 500:1 to 1:500, preferably from 100:1 to 1:100 more preferably from 50:1 to 1:50, most preferably from 20:1 to 1:20, and utmost preferred from 10:1 to 1:10, and the weight ratio of compounds (II) to (III) is from 100:1 to 1:100 more preferably from 50:1 to 1:50, most preferably from 20:1 to 1:20, and utmost preferred from 10:1 to 1:10; and the weight ratio of compounds (I) to (III) is from 100:1 to 1:100 more preferably from 50:1 to 1:50, most preferably from 20:1 to 1:20, and utmost preferred from 10:1 to 1:10.

Moreover, this invention relates to methods for combating and/or controlling pests, particularly invertebrate pests, insects, arachnids or nematodes by using compositions according to the present invention comprising compound (I) and at least one compound (II) and optionally one or two compound(s) (III) in synergistically effective amount and to a method for preparing such compositions.

Further, the present invention relates to the methods for treating and/or protecting plants from attack or infestation pests comprising contacting the plant, or soil or water in which the pest is growing with the composition according to the present invention.

The present invention further relates to a method of protecting plant propagation material (preferably seeds) and/or the plants which grow there from, which method comprises treating the plant propagation material (preferably seeds) before sowing and/or after pregermination with a composition according to the present invention.

The present invention further relates to a process for preparing the pesticidal composition, said process comprising the step of applying to the locus the compounds (I), (II) and (III) simultaneously, that is jointly or separately, or in succession. The present invention further relates to a process for preparing the pesticidal composition, said process comprising the step of mixing the compounds (I), (II), and (III).

The term “plant propagation material” is to be understood to denote all the generative parts of the plant such as seeds and vegetative plant material such as cuttings and tubers (e.g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil. These young plants may also be protected before transplantation by a total or partial treatment by immersion or pouring. In a particular preferred embodiment, the term propagation material denotes seeds. As used herein, the term “pest” is considered to include any harmful organisms including insects, acarids, and nematodes as well as harmful fungi when an additional active component of the composition of the present invention is a fungicide.

Another problem underlying the present invention is the desire for compositions that improve the health of plants, a process which is commonly and hereinafter referred to as “plant health”. It was therefore an object of the present invention to provide pesticidal mixtures which solve the problems of reducing the dosage rate and/or enhancing the spectrum of activity and/or combining knock-down activity with prolonged control and/or to resistance management and/or promoting the health of plants.

We have found that this object is, in part or in whole, achieved by the compositions comprising the pesticidal active compounds as defined in the present invention.

Therefore, the present invention further relates to plant-protecting active ingredient combination having synergistically enhanced action of improving the health of plants and to a method of applying such inventive mixtures to the plants.

The term plant health comprises various sorts of improvements of plants that are not connected to the control of pests. For example, advantageous properties that may be mentioned are improved crop characteristics including: emergence, crop yields, protein content, oil content, starch content, more developed root system (improved root growth), improved stress tolerance (e.g. against drought, heat, salt, UV, water, cold), reduced ethylene (reduced production and/or inhibition of reception), tillering increase, increase in plant height, bigger leaf blade, less dead basal leaves, stronger tillers, greener leaf color, pigment content, photosynthetic activity, less input needed (such as fertilizers or water), less seeds needed, more productive tillers, earlier flowering, early grain maturity, less plant verse (lodging), increased shoot growth, enhanced plant vigor, increased plant stand and early and better germination; or any other advantages familiar to a person skilled in the art.

Especially, it has been found that the combination as defined in the outset show markedly enhanced action against pests compared to the control rates that are possible with the individual compounds and/or is suitable for improving the health of plants when applied to plants, parts of plants, seeds, or at their locus of growth. It has been found that the action of the inventive compositions goes far beyond the insecticidal and/or fungicidal and/or plant health improving action of the combination of active compounds according to the present invention than the action of the compounds taken alone.

Moreover, we have found that simultaneous, that is joint or separate, application of the compound (I) and the compound (II) (and/or the compounds (III) for the inventive ternary and quaternary mixtures) or successive application of the compound (I) and the compound (II) (and/or the compounds (III) for the inventive ternary and quaternary mixtures) allows enhanced control of pests, that means animal pests, and/or harmful fungi, compared to the control rates that are possible with the individual compounds (synergistic mixtures).

Moreover, we have found that simultaneous, that is joint or separate, application of the compound (I) and the compound (II) (or the compounds (III) for the inventive ternary and quaternary mixtures) or successive application of the compound (I) and the compound (II), and further fungicidal compound(s) (III) provides enhanced plant health effects compared to the plant health effects that are possible with the individual compounds.

The synergistic ratio by weight of compounds (I) and (II) is from 500:1 to 1:500, preferably from 100:1 to 1:100, more preferably from 50:1 to 1:50, most preferably from 20:1 to 1:20. Utmost preferred ratios are from 10:1 to 1:10.

For the synergistic ternary mixtures i.e. when compound (III) is present, the synergistic ratio by weight of compounds (I) to (II) is from 500:1 to 1:500, preferably from 100:1 to 1:100, more preferably from 50:1 to 1:50, most preferably from 20:1 to 1:20 and utmost preferred ratios are from 10:1 to 1:10; and the synergistic ratio by weight of compounds (I) to (III) is from 500:1 to 1:500, preferably from 100:1 to 1:100, more preferably from 50:1 to 1:50, most preferably from 20:1 to 1:20 and utmost preferred ratios are from 10:1 to 1:10; and the synergistic ratio by weight of compounds (II) to (III) is from 500:1 to 1:500, preferably from 100:1 to 1:100, more preferably from 50:1 to 1:50, most preferably from 20:1 to 1:20 and utmost preferred ratios are from 10:1 to 1:10.

The term “synergstic effect” is understood to refer in particular to that defined by Colby's formula (Colby, S. R., “Calculating synergistic and antagonistic responses of herbicide combinations”, Weeds, 15, pp. 20-22, 1967).

The term “synergistic effect” is also understood to refer to that defined by application of the Tammes method, (Tammes, P. M. L., “Isoboles, a graphic representation of synergism in pesticides”, Netherl. J. Plant Pathol. 70, 1964).

The components can be used individually or already partially or completely mixed with one another to prepare the composition according to the invention. It is also possible for them to be packaged and used as combination such as a kit of parts.

In general, “synergistically effective amounts” means that the active compounds i.e. the compounds (I), (II) and the compound (III) are usually applied in a weight ratio as above described and wherein synergism is observed. Synergism is observed if the insecticidal effect of the combined active compounds (i.e. compounds (I), (II) and (III)) observed (i.e. measured) is greater than the expected calculated effect of them.

Embodiments and preferred combination of compounds (I), (II) and optionally (III) in synergistically effective amounts and optionally additional pesticide according to the present invention for use in pesticidal methods and for insecticidal application purposes are outlined in the following paragraphs.

The remarks made below concerning preferred embodiments of the compounds combination in synergistically effective amounts according to the invention are valid both on their own and, in particular, in every possible combination with each other and where applicable, the uses, the methods and the compositions according to the invention.

Even if not explicitly written, the synergistically effective amounts of compounds (I) and (II) in accordance with the present invention apply to all possible combinations, wherein the ratio by weight of these synergistically effective amounts of compounds (I) and (II) is from 500:1 to 1:500, preferably from 100:1 to 1:100 more preferably from 50:1 to 1:50, most preferably from 20:1 to 1:20, and utmost preferred from 10:1 to 1:10.

Even if not explicitly written, the synergistically effective amounts of compounds (I), (II) and (III) in accordance with the present invention apply to all possible combinations, wherein the ratio by weight of these synergistically effective amounts of compounds (I), (II) and (III) is for the compounds (I) to (II) from 500:1 to 1:500, preferably from 100:1 to 1:100, more preferably from 50:1 to 1:50, most preferably from 20:1 to 1:20 and utmost preferred ratios are from 10:1 to 1:10; for the compounds (I) to (III) from 500:1 to 1:500, preferably from 100:1 to 1:100, more preferably from 50:1 to 1:50, most preferably from 20:1 to 1:20 and utmost preferred ratios are from 10:1 to 1:10; and for the compounds (II) to (III) from 500:1 to 1:500, preferably from 100:1 to 1:100, more preferably from 50:1 to 1:50, most preferably from 20:1 to 1:20 and utmost preferred ratios are from 10:1 to 1:10.

In a particular embodiment, the benzoylurea compound (I) is flufenoxuron.

In another particular embodiment, the benzoylurea compound (I) is teflubenzuron.

In an embodiment, the insecticidal compound (II) from the group of nicotinic acetylcholine receptors agonist is selected from the group of acetamiprid, clothianidin, cycloxaprid, imidacloprid, nitenpyram, thiacloprid, thiamethoxam and 1-[(6-chloro-3-pyridyl)methyl]-7-methyl-8-nitro-5-propoxy-3,5,6,7-tetrahydro-2H-imidazo[1,2-a]pyridine (hereinafter referred as P1).

In a further embodiment, the insecticidal compound (II) is clothianidin, cycloxaprid, nitenpyram, thiacloprid and 1-[(6-chloro-3-pyridyl)methyl]-7-methyl-8-nitro-5-propoxy-3,5,6,7-tetrahydro-2H-imidazo[1,2-a]pyridine (hereinafter referred as P1).

In a further embodiment, the insecticidal compound (II) is clothianidin, cycloxaprid, nitenpyram and thiacloprid.

In another embodiment, the insecticidal compound (II) is acetamiprid, clothianidin, cycloxaprid, nitenpyram, thiacloprid or thiamethoxam.

In a further embodiment, the insecticidal compound (II) is clothianidin, cycloxaprid, nitenpyram, thiacloprid or thiamethoxam.

In a further embodiment, the insecticidal compound (II) is clothianidin, thiacloprid or thiamethoxam.

In a further embodiment, the insecticidal compound (II) is clothianidin or thiacloprid.

In another embodiment, the insecticidal compound (II) from the group of nicotinic acetylcholine receptors agonist is clothianidin, cycloxaprid, imidacloprid, nitenpyram, thiacloprid or thiamethoxam.

In a further embodiment, the insecticidal compound (II) from the group of nicotinic acetylcholine receptors agonist is clothianidin, cycloxaprid, imidacloprid, nitenpyram or thiacloprid.

In another embodiment, the insecticidal compound (II) is acetamiprid, clothianidin, imidacloprid or thiacloprid, thiamethoxam.

In another embodiment, the insecticidal compound (II) is clothianidin, imidacloprid, thiacloprid or thiamethoxam.

In another embodiment, the insecticidal compound (II) is acetamiprid or thiamethoxam.

In another embodiment, the insecticidal compound (II) is acetamiprid.

In another embodiment, the insecticidal compound (II) is thiamethoxam.

In a particular embodiment, the insecticidal compound (II) is clothianidin.

In a particular embodiment, the insecticidal compound (II) is thiacloprid. The present invention further relates to the pesticidal compositions as above defined which further contain one or more pesticidal active components.

In an embodiment, the insecticidal compound (III) is a fungicidal compound (III) which is a compound IIIA being azoxystrobin, pyraclostrobin or trifloxystrobin. In a particular embodiment, the compound IIIA is pyraclostrobin.

In an other embodiment, the fungicidal compound (III) is a compound IIIB being bixafen, boscalid or fluxapyroxad. In a particular embodiment, the compound IIIB is fluxapyroxad.

The present invention further relates to the pesticidal compositions as above defined which further comprise one or more pesticidal active components.

Preferably the further fourth pesticidal compound (III) is a fungicidal compound. Therefore, another particular embodiment of the present invention relates to the compositions according to the present invention comprising at least one further additional pesticidal active component selected from the list as follows:

the fungicides azoxystrobin, coumethoxystrobin, coumoxystrobin, dimoxystrobin, enestroburin, fenaminstrobin, fenoxystrobin/flufenoxystrobin, fluoxastrobin, kresoxim-methyl, metominostrobin, orysastrobin, picoxystrobin, pyraclostrobin, pyrametostrobin, pyraoxystrobin, trifloxystrobin, pyribencarb, triclopyricarb/chlorodincarb, bixafen, boscalid, fluxapyroxad, fluopyram, isopyrazam, penflufen, penthiopyrad, sedaxane.

Therefore, the present invention further relates to the embodiments which are herafter listed. In an embodiment, the fungicidal compound (III) is a compound IIIA being azoxystrobin, pyraclostrobin or trifloxystrobin. In a particular embodiment, the compound IIIA is pyraclostrobin. In an embodiment, the fungicidal compound (III) is a compound IIIB being bixafen, boscalid or fluxapyroxad. In a particular embodiment, the compound IIIB is fluxapyroxad.

In Table 1, the following combinations in synergistically effective amounts, preferably in a ratio by weight from 500:1 to 1:500, preferably from 100:1 to 1:100 more preferably from 50:1 to 1:50, most preferably from 20:1 to 1:20, and utmost preferred from 10:1 to 1:10. are especially preferred embodiments of the present invention:

TABLE 1
C-1 to C-101 corresponds to compositions according to the
present invention wherein compound (I) is teflubenzuron:

| Combination | | First additional | Further additional |
|---|---|---|---|
| No. | Compound (II) | compound (III) | compound (III) |
| C-1 | clothianidin | — | — |
| C-2 | cycloxaprid | — | — |
| C-3 | nitenpyram | — | — |
| C-4 | thiacloprid | — | — |
| C-5 | P1 | — | — |
| C-6 | acetamiprid | azoxystrobin | — |
| C-7 | clothianidin | azoxystrobin | — |
| C-8 | cycloxaprid | azoxystrobin | — |
| C-9 | imidaclorid | azoxystrobin | — |
| C-10 | nitenpyram | azoxystrobin | — |
| C-11 | thiacloprid | azoxystrobin | — |
| C-12 | thiamethoxam | azoxystrobin | — |
| C-13 | P1 | azoxystrobin | — |
| C-14 | acetamiprid | dimoxystrobin | — |
| C-15 | clothianidin | dimoxystrobin | — |
| C-16 | cycloxaprid | dimoxystrobin | — |
| C-17 | imidaclorid | dimoxystrobin | — |
| C-18 | nitenpyram | dimoxystrobin | — |
| C-19 | thiacloprid | dimoxystrobin | — |
| C-20 | thiamethoxam | dimoxystrobin | — |
| C-21 | P1 | dimoxystrobin | — |
| C-22 | acetamiprid | fluoxastrobin | — |
| C-23 | clothianidin | fluoxastrobin | — |
| C-24 | cycloxaprid | fluoxastrobin | — |
| C-25 | imidaclorid | fluoxastrobin | — |
| C-26 | nitenpyram | fluoxastrobin | — |
| C-27 | thiacloprid | fluoxastrobin | — |
| C-28 | thiamethoxam | fluoxastrobin | — |
| C-29 | P1 | fluoxastrobin | — |
| C-30 | acetamiprid | kresoxim-methyl | — |
| C-31 | clothianidin | Kresoxim-methyl | — |
| C-32 | cycloxaprid | Kresoxim-methyl | — |
| C-33 | imidaclorid | kresoxim-methyl | — |
| C-34 | nitenpyram | kresoxim-methyl | — |
| C-35 | thiacloprid | kresoxim-methyl | — |
| C-36 | thiamethoxam | kresoxim-methyl | — |
| C-37 | P1 | kresoxim-methyl | — |
| C-38 | acetamiprid | picoxystrobin | — |
| C-39 | clothianidin | picoxystrobin | — |
| C-40 | cycloxaprid | picoxystrobin | — |
| C-41 | imidaclorid | picoxystrobin | — |
| C-42 | nitenpyram | picoxystrobin | — |
| C-43 | thiacloprid | picoxystrobin | — |
| C-44 | thiamethoxam | picoxystrobin | — |
| C-45 | P1 | picoxystrobin | — |
| C-46 | acetamiprid | pyraclostrobin | — |
| C-47 | clothianidin | pyraclostrobin | — |
| C-48 | cycloxaprid | pyraclostrobin | — |
| C-49 | imidaclorid | pyraclostrobin | — |
| C-50 | nitenpyram | pyraclostrobin | — |
| C-51 | thiacloprid | pyraclostrobin | — |
| C-52 | thiamethoxam | pyraclostrobin | — |
| C-53 | P1 | pyraclostrobin | — |
| C-54 | acetamiprid | trifloxystrobin | — |
| C-55 | clothianidin | trifloxystrobin | — |
| C-56 | cycloxaprid | trifloxystrobin | — |
| C-57 | imidaclorid | trifloxystrobin | — |
| C-58 | nitenpyram | trifloxystrobin | — |
| C-59 | thiacloprid | trifloxystrobin | — |
| C-60 | thiamethoxam | trifloxystrobin | — |
| C-61 | P1 | trifloxystrobin | — |
| C-62 | acetamiprid | pyribencarb | — |
| C-63 | clothianidin | pyribencarb | — |
| C-64 | cycloxaprid | pyribencarb | — |
| C-65 | imidaclorid | pyribencarb | — |
| C-66 | nitenpyram | pyribencarb | — |
| C-67 | thiacloprid | pyribencarb | — |
| C-68 | thiamethoxam | pyribencarb | — |
| C-69 | P1 | pyribencarb | — |
| C-70 | acetamiprid | bixafen | — |
| C-71 | clothianidin | bixafen | — |
| C-72 | cycloxaprid | bixafen | — |
| C-73 | imidaclorid | bixafen | — |
| C-74 | nitenpyram | bixafen | — |
| C-75 | thiacloprid | bixafen | — |
| C-76 | thiamethoxam | bixafen | — |
| C-77 | P1 | bixafen | — |
| C-78 | acetamiprid | boscalid | — |
| C-79 | clothianidin | boscalid | — |
| C-80 | cycloxaprid | boscalid | — |
| C-81 | imidaclorid | boscalid | — |
| C-82 | nitenpyram | boscalid | — |
| C-83 | thiacloprid | boscalid | — |
| C-84 | thiamethoxam | boscalid | — |
| C-85 | P1 | boscalid | — |
| C-86 | acetamiprid | fluxapyroxad | — |
| C-87 | clothianidin | fluxapyroxad | — |
| C-88 | cycloxaprid | fluxapyroxad | — |
| C-89 | imidaclorid | fluxapyroxad | — |
| C-90 | nitenpyram | fluxapyroxad | — |
| C-91 | thiacloprid | fluxapyroxad | — |
| C-92 | thiamethoxam | fluxapyroxad | — |
| C-93 | P1 | fluxapyroxad | — |
| C-94 | acetamiprid | fluxapyroxad | pyraclostrobin |
| C-95 | clothianidin | fluxapyroxad | pyraclostrobin |
| C-96 | cycloxaprid | fluxapyroxad | pyraclostrobin |
| C-97 | imidaclorid | fluxapyroxad | pyraclostrobin |
| C-98 | nitenpyram | fluxapyroxad | pyraclostrobin |
| C-99 | thiacloprid | fluxapyroxad | pyraclostrobin |
| C-100 | thiamethoxam | fluxapyroxad | pyraclostrobin |
| C-101 | P1 | fluxapyroxad | pyraclostrobin |

TABLE 2
C-102 to C-203 correspond to compositions according to
the present invention wherein compound (I) is flufenoxuron

| Combination | | First additional | Further additional |
|---|---|---|---|
| No. | Compound (II) | compound (III) | compound (III) |
| C-102 | clothianidin | — | — |
| C-103 | cycloxaprid | — | — |
| C-104 | imidacloprid | — | — |
| C-105 | nitenpyram | — | — |
| C-106 | thiacloprid | — | — |
| C-107 | P1 | — | — |
| C-108 | acetamiprid | azoxystrobin | — |
| C-109 | clothianidin | azoxystrobin | — |
| C-110 | cycloxaprid | azoxystrobin | — |
| C-111 | imidaclorid | azoxystrobin | — |
| C-112 | nitenpyram | azoxystrobin | — |
| C-113 | thiacloprid | azoxystrobin | — |
| C-114 | thiamethoxam | azoxystrobin | — |
| C-115 | P1 | azoxystrobin | — |
| C-116 | acetamiprid | dimoxystrobin | — |
| C-117 | clothianidin | dimoxystrobin | — |
| C-118 | cycloxaprid | dimoxystrobin | — |
| C-119 | imidaclorid | dimoxystrobin | — |
| C-120 | nitenpyram | dimoxystrobin | — |
| C-121 | thiacloprid | dimoxystrobin | — |
| C-122 | thiamethoxam | dimoxystrobin | — |
| C-123 | P1 | dimoxystrobin | — |
| C-124 | acetamiprid | fluoxastrobin | — |
| C-125 | clothianidin | fluoxastrobin | — |
| C-126 | cycloxaprid | fluoxastrobin | — |
| C-127 | imidaclorid | fluoxastrobin | — |
| C-128 | nitenpyram | fluoxastrobin | — |
| C-129 | thiacloprid | fluoxastrobin | — |
| C-130 | thiamethoxam | fluoxastrobin | — |
| C-131 | P1 | fluoxastrobin | — |
| C-132 | acetamiprid | kresoxim-methyl | — |
| C-133 | clothianidin | Kresoxim-methyl | — |
| C-134 | cycloxaprid | Kresoxim-methyl | — |
| C-135 | imidaclorid | kresoxim-methyl | — |
| C-136 | nitenpyram | kresoxim-methyl | — |
| C-137 | thiacloprid | kresoxim-methyl | — |
| C-138 | thiamethoxam | kresoxim-methyl | — |
| C-139 | P1 | kresoxim-methyl | — |
| C-140 | acetamiprid | picoxystrobin | — |
| C-141 | clothianidin | picoxystrobin | — |
| C-142 | cycloxaprid | picoxystrobin | — |
| C-143 | imidaclorid | picoxystrobin | — |
| C-144 | nitenpyram | picoxystrobin | — |
| C-145 | thiacloprid | picoxystrobin | — |
| C-146 | thiamethoxam | picoxystrobin | — |
| C-147 | P1 | picoxystrobin | — |
| C-148 | acetamiprid | pyraclostrobin | — |
| C-149 | clothianidin | pyraclostrobin | — |
| C-150 | cycloxaprid | pyraclostrobin | — |
| C-151 | imidaclorid | pyraclostrobin | — |
| C-152 | nitenpyram | pyraclostrobin | — |
| C-153 | thiacloprid | pyraclostrobin | — |
| C-154 | thiamethoxam | pyraclostrobin | — |
| C-155 | P1 | pyraclostrobin | — |
| C-156 | acetamiprid | trifloxystrobin | — |
| C-157 | clothianidin | trifloxystrobin | — |
| C-158 | cycloxaprid | trifloxystrobin | — |
| C-159 | imidaclorid | trifloxystrobin | — |
| C-160 | nitenpyram | trifloxystrobin | — |
| C-161 | thiacloprid | trifloxystrobin | — |
| C-162 | thiamethoxam | trifloxystrobin | — |
| C-163 | P1 | trifloxystrobin | — |
| C-164 | acetamiprid | pyribencarb | — |
| C-165 | clothianidin | pyribencarb | — |
| C-166 | cycloxaprid | pyribencarb | — |
| C-167 | imidaclorid | pyribencarb | — |
| C-168 | nitenpyram | pyribencarb | — |
| C-169 | thiacloprid | pyribencarb | — |
| C-170 | thiamethoxam | pyribencarb | — |
| C-171 | P1 | pyribencarb | — |
| C-172 | acetamiprid | bixafen | — |
| C-173 | clothianidin | bixafen | — |
| C-174 | cycloxaprid | bixafen | — |
| C-175 | imidaclorid | bixafen | — |
| C-176 | nitenpyram | bixafen | — |
| C-177 | thiacloprid | bixafen | — |
| C-178 | thiamethoxam | bixafen | — |
| C-179 | P1 | bixafen | — |
| C-180 | acetamiprid | boscalid | — |
| C-181 | clothianidin | boscalid | — |
| C-182 | cycloxaprid | boscalid | — |
| C-183 | imidaclorid | boscalid | — |
| C-184 | nitenpyram | boscalid | — |
| C-185 | thiacloprid | boscalid | — |
| C-186 | thiamethoxam | boscalid | — |
| C-187 | P1 | boscalid | — |
| C-188 | acetamiprid | fluxapyroxad | — |
| C-189 | clothianidin | fluxapyroxad | — |
| C-190 | cycloxaprid | fluxapyroxad | — |
| C-191 | imidaclorid | fluxapyroxad | — |
| C-192 | nitenpyram | fluxapyroxad | — |
| C-193 | thiacloprid | fluxapyroxad | — |
| C-194 | thiamethoxam | fluxapyroxad | — |
| C-195 | P1 | fluxapyroxad | — |
| C-196 | acetamiprid | fluxapyroxad | pyraclostrobin |
| C-197 | clothianidin | fluxapyroxad | pyraclostrobin |
| C-198 | cycloxaprid | fluxapyroxad | pyraclostrobin |
| C-199 | imidaclorid | fluxapyroxad | pyraclostrobin |
| C-200 | nitenpyram | fluxapyroxad | pyraclostrobin |
| C-201 | thiacloprid | fluxapyroxad | pyraclostrobin |
| C-202 | thiamethoxam | fluxapyroxad | pyraclostrobin |
| C-203 | P1 | fluxapyroxad | pyraclostrobin |

Flufenoxuron and teflubenzuron, their preparation and their pesticidal activities are known from the literature (cf. U.S. Pat. No. 5,874,615, U.S. Pat. No. 4,698,365 and EP 52833).

The insecticidal compounds (II) from the group of nicotinic acetylcholine receptors agonist consisting of acaetamiprid, clothianidin, imidacloprid, nitenpyram, thiacloprid and thiamethoxam, their preparation and pesticidal activities are likewise known from the literature and can e.g. be found in The Pesticidal Manual, 14th edition, C. D. S Tomlin, British Crop Protection Council (2006), particularly in the following respective pages: 209, 358, 598, 754 and 1021.

Cycloxaprid is known from US 2011269751.

Compound (P1) 1-[(6-chloro-3-pyridyl)-methyl]-7-methyl-8-nitro-5-propoxy-3,5,6,7-tetrahydro-2H-imidazo[1,2-a]pyridine is known from US 2009111847.

Within the binary compositions according to the present invention (i.e. having two pesticidal active compounds), the combinations of the above tables numbered C-1, C-4, C-102, C-104 and C-106 are preferred.

Within the ternary compositions according to the present invention (i.e having three pesticidal active compounds), the combinations of the above tables numbered C-47, C-49, C-52, C-87, C-89, C-92, C-149, C-151, C-154, C-189, C-191 and C-194 are preferred. Within those ternary compositions, more preferred are the compositions numbered C-52, C-92, C-154 and C-194. Within the quaternary compositions according to the present invention (i.e having four pesticidal active compounds), the combinations numbered C-95, C-97 and C-100 are preferred. In an other embodiment within the quaternary compositions according to the present invention, the combination numbered C-95, C-97, C-100 and C-202 are preferred. Most preferred quaternary compositions are C-100 and C-202, and particularly preferred is C-100.

When preparing the composition according to the present invention, it is preferred to employ the pure benzoylurea compound (I) and the pure compound (II) from the group of nicotinic acetylcholine receptors agonist, to which further pesticidal active compounds (III) may be optionally added, e.g. fungicide against harmful fungi or growth-regulating active compounds.

The compositions comprising the compounds (I), (II) and (III) according to the present invention or the simultaneous or successive use of the compounds of formulae (I), (II) and (III) exhibit outstanding synergistical action against pests such as animal pests, e.g arachnids, myriapedes and insects as well as nematodes.

The compositions comprising the compounds (I), (II) and (III) according to the present invention are especially suitable for efficiently combating the following pests:

Insects from the order of the lepidopterans (Lepidoptera), for example Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Chematobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Euproctis, Evetria bouliana, Feltia subterranea, Galleria mellonella, Grapholitha funebrana, Grapholitha molesta, Heliothis armigera, Heliothis virescens, Heliothis zea, Hellula undalis, Heterocera, Hibernia defoliaria, Hyphantria cunea, Hyponomeuta malinellus, Keiferia lycopersicella, Lambdina fiscellaria, Laphygma exigua, Lasiocampidae, Leucoptera coffeella, Leucoptera scitella, Lithocolletis blancardella, Lobesia botrana, Loxostege sticticalis, Lymantriidae family, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis;
beetles (Coleoptera), for example Agrilus sinuatus, Agriotes lineatus, Agriotes obscurus, Amphimallus solstitialis, Anisandrus dispar, Anthonomus grandis, Anthonomus pomorum, Aphthona euphoridae, Athous haemorrhoidalis, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Cetonia aurata, Ceuthorrhynchus assimilis, Ceuthorrhynchus napi, Chaetocnema tibialis, Conoderus vespertinus, Crioceris asparagi, Ctenicera ssp., Diabrotica longicornis, Diabrotica semipunctata, Diabrotica 12-punctata Diabrotica speciosa, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Otiorrhynchus sulcatus, Otiorrhynchus ovatus, Phaedon cochleariae, Phyllobius pyri, Phyllotreta chrysocephala, Phyllophaga sp., Phyllopertha horticola, Phyllotreta nemorum, Phyllotreta striolata, Popillia japonica, Sitona lineatus and Sitophilus granaria; flies, mosquitoes (Diptera), e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Ceratitis capitata, Chrysomya bezziana, Chrysomya hominivorax, Chrysomya macellaria, Chrysops discalis, Chrysops silacea, Chrysops atlanticus, Cochliomyia hominivorax, Contarinia sorghicola Cordylobia anthropophaga, Culicoides furens, Culex pipiens, Culex nigripalpus, Culex quinquefasciatus, Culex tarsalis, Culiseta inornata, Culiseta melanura, Dacus cucurbitae, Dacus oleae, Dasineura brassicae, Delia antique, Delia coarctata, Delia platura, Delia radicum, Dermatobia hominis, Fannia canicularis, Geomyza Tripunctata, Gasterophilus intestinalis, Glossina morsitans, Glossina palpalis, Glossina fuscipes, Glossina tachinoides, Haematobia irritans, Haplodiplosis equestris, Hippelates spp., Hylemyia platura, Hypoderma lineata, Leptoconops torrens, Liriomyza sativae, Liriomyza trifolii, Lucilia caprina, Lucilia cuprina, Lucilia sericata, Lycoria pectoralis, Mansonia titillanus, Mayetiola destructor, Musca autumnalis, Musca domestica, Muscina stabulans, Oestrus ovis, Opomyza florum, Oscinella frit, Pegomya hysocyami, Phorbia antiqua, Phorbia brassicae, Phorbia coarctata, Phlebotomus argentipes, Psorophora columbiae, Psila rosae, Psorophora discolor, Prosimulium mixtum, Rhagoletis cerasi, Rhagoletis pomonella, Sarcophaga haemorrhoidalis, Sarcophaga spp., Simulium vittatum, Stomoxys calcitrans, Tabanus bovinus, Tabanus atratus, Tabanus lineola, Tabanus similis, Tipula oleracea, and Tipula paludosa;
thrips (Thysanoptera), e.g. Dichromothrips corbetti, Dichromothrips ssp., Frankliniella fusca, Frankliniella occidentalis, Frankliniella tritici, Scirtothrips citri, Thrips oryzae, Thrips palmi and Thrips tabaci;
termites (Isoptera), e.g. Calotermes flavicollis, Leucotermes flavipes, Heterotermes aureus, Reticulitermes flavipes, Reticulitermes virginicus, Reticulitermes lucifugus, Reticulitermes santonensis, Reticulitermes grassei, Termes natalensis, and Coptotermes formosanus;
cockroaches (Blattaria—Blattodea), e.g. Blattella germanica, Blattella asahinae, Periplaneta americana, Periplaneta japonica, Periplaneta brunnea, Periplaneta fuligginosa, Periplaneta australasiae, and Blatta orientalis;
bugs, aphids, leafhoppers, whiteflies, scale insects, cicadas (Hemiptera), e.g. Acrosternum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis, Thyanta perditor, Acyrthosiphon onobrychis, Adelges laricis, Aphidula nasturtii, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Bemisia argentifolii, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzus persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, Viteus vitifolii, Cimex lectularius, Cimex hemipterus, Reduvius senilis, Triatoma spp., and Arilus critatus;
ants, bees, wasps, sawflies (Hymenoptera), e.g. Athalia rosae, Atta cephalotes, Atta capiguara, Atta cephalotes, Atta laevigata, Atta robusta, Atta sexdens, Atta texana, Crematogaster spp., Hoplocampa minuta, Hoplocampa testudinea, Lasius niger, Monomorium pharaonis, Solenopsis geminata, Solenopsis invicta, Solenopsis richteri, Solenopsis xyloni, Pogonomyrmex barbatus, Pogonomyrmex californicus, Pheidole megacephala, Dasymutilla occidentalis, Bombus spp., Vespula squamosa, Paravespula vulgaris, Paravespula pennsylvanica, Paravespula germanica, Dolichovespula maculata, Vespa crabro, Polistes rubiginosa, Camponotus floridanus, and Linepithema, humile;
crickets, grasshoppers, locusts (Orthoptera), e.g. Acheta domestica, Gryllotalpa gryllotalpa, Locusta migratoria, Melanoplus bivittatus, Melanoplus femurrubrum, Melanoplus mexicanus, Melanoplus sanguinipes, Melanoplus spretus, Nomadacris septemfasciata, Schistocerca americana, Schistocerca gregaria, Dociostaurus maroccanus, Tachycines asynamorus, Oedaleus senegalensis, Zonozerus variegatus, Hieroglyphus daganensis, Kraussaria angulifera, Calliptamus italicus, Chortoicetes terminifera, and Locustana pardalina;
arachnoidea, such as arachnids (Acarina), e.g. of the families Argasidae, Ixodidae and Sarcoptidae, such as Amblyomma americanum, Amblyomma variegatum, Ambryomma maculatum, Argas persicus, Boophilus annulatus, Boophilus decoloratus, Boophilus microplus, Dermacentor silvarum, Dermacentor andersoni, Dermacentor variabilis, Hyalomma truncatum, Ixodes ricinus, Ixodes rubicundus, Ixodes scapularis, Ixodes holocyclus, Ixodes pacificus, Ornithodorus moubata, Ornithodorus hermsi, Ornithodorus turicata, Ornithonyssus bacoti, Otobius megnini, Dermanyssus gallinae, Psoroptes ovis, Rhipicephalus sanguineus, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni; Tarsonemidae spp. such as Phytonemus pallidus and Polyphagotarsonemus latus; Tenuipalpidae spp. such as Brevipalpus phoenicis; Tetranychidae spp. such as Tetranychus cinnabarinus, Tetranychus kanzawai, Tetranychus pacificus, Tetranychus telarius and Tetranychus urticae, Panonychus ulmi, Panonychus citri, and Oligonychus pratensis; Araneida, e.g. Latrodectus mactans, and Loxosceles reclusa;
fleas (Siphonaptera), e.g. Ctenocephalides felis, Ctenocephalides canis, Xenopsylla cheopis, Pulex irritans, Tunga penetrans, and Nosopsyllus fasciatus;
silverfish, firebrat (Thysanura), e.g. Lepisma saccharina and Thermobia domestica;
centipedes (Chilopoda), e.g. Scutigera coleoptrata;
millipedes (Diplopoda), e.g. Narceus spp.;
Earwigs (Dermaptera), e.g. forficula auricularia;
lice (Phthiraptera), e.g. Pediculus humanus capitis, Pediculus humanus corporis, Pthirus pubis, Haematopinus eurysternus, Haematopinus suis, Linognathus vituli, Bovicola bovis, Menopon gallinae, Menacanthus stramineus and Solenopotes capillatus;
Collembola (springtails), e.g. Onychiurus ssp.

The compositions of the present invention are also suitable for controlling nematodes: plant parasitic nematodes such as root knot nematodes, Meloidogyne hapla, Meloidogyne incognita, Meloidogyne javanica, and other Meloidogyne species; cyst-forming nematodes, Globodera rostochiensis and other Globodera species; Heterodera avenae, Heterodera glycines, Heterodera schachtii, Heterodera trifolii, and other Heterodera species; Seed gall nematodes, Anguina species; Stem and foliar nematodes, Aphelenchoides species; Sting nematodes, Belonolaimus longicaudatus and other Belonolaimus species; Pine nematodes, Bursaphelenchus xylophilus and other Bursaphelenchus species; Ring nematodes, Criconema species, Criconemella species, Criconemoides species, Mesocriconema species; Stem and bulb nematodes, Ditylenchus destructor, Ditylenchus dipsaci and other Ditylenchus species; Awl nematodes, Dolichodorus species; Spiral nematodes, Heliocotylenchus multicinctus and other Helicotylenchus species; Sheath and sheathoid nematodes, Hemicycliophora species and Hemicriconemoides species; Hirshmanniella species; Lance nematodes, Hoploaimus species; false rootknot nematodes, Nacobbus species; Needle nematodes, Longidorus elongatus and other Longidorus species; Lesion nematodes, Pratylenchus neglectus, Pratylenchus penetrans, Pratylenchus curvitatus, Pratylenchus goodeyi and other Pratylenchus species; Burrowing nematodes, Radopholus similis and other Radopholus species; Reniform nematodes, Rotylenchus robustus and other Rotylenchus species; Scutellonema species; Stubby root nematodes, Trichodorus primitivus and other Trichodorus species, Paratrichodorus species; Stunt nematodes, Tylenchorhynchus claytoni, Tylenchorhynchus dubius and other Tylenchorhynchus species; Citrus nematodes, Tylenchulus species; Dagger nematodes, Xiphinema species; and other plant parasitic nematode species.

The compositions of the present invention are particularly useful for controlling, or combating, or treating, or preventing or protecting each of the individual group of target pests as above listed as well as each combination thereof. Each of the groups or subgroup of the above listed pests constitute per se, independently of every possible combination a particular preferred target pests for which the compositions of the present invention are useful, and therefore relating to particular embodiments of the present invention. Useful in this context is to be understood as useful for:

combating such pest(s) or,
controlling such pest(s) or,
protecting from attack by such pest(s) or,
treating against infestation or infection by such pest(s) or,
controlling against infestation or infection by such pest(s) or,
preventing against infestation or infection by such pest(s) or,
protecting against infestation or infection by such pest(s).

The compositions according to the present invention are particularly useful for controlling insects, preferably piercing-sucking insects such as insects from the genera Thysanoptera, Diptera and Hemiptera.

In a very preferred embodiment, the insect is selected from foliar insect pests. An embodiment of the invention relates to a method of combating or controlling foliar insects selected from the order Lepidoptera. Within this embodiment, preference is given to insects from the family of Noctuidae, in particular to insects selected from the group consisting of Alabama argillacea, Anticarsia gemmatalis, Heliothis virescens, Pseudoplusia includens and Spodoptera frugiperda. Further preference is given to insects selected from the families consisting of Pieridae (in particular Ascia monuste orseis as target), Nymphalidae (in particular Dione juno juno as target), Gelechiidae (in particular Phthorimaea operculella and tuta absoluta as targets) and Plutellidae (in particular Plutella xylostella as target).

Further embodiment of the invention relates to a method of combating or controlling foliar insects selected from sucking insects, in particular from lygus bugs, aphids and whiteflies.

Further embodiment of the invention relates to a method of combating or controlling foliar insects selected from the order Hemiptera.

Further embodiment of the invention relates to a method of combating or controlling foliar insects selected from planthoppers (Delphacidae) and leafhoppers (Deltocephalidae). Among the planthoppers, the smaller brown planthopper (Laodelphax striatellus), brown planthopper (Nilaparvata lugens) and white-backed rice planthopper (Sogatella furcifera) are preferred target insects. Among the leafhoppers, green rice leafhoppers (Nephotettix cincticeps, Nephotettix nigropictus and Nephotettix virescens) are preferred target insects.

Further embodiment of the invention relates to a method of combating or controlling foliar insects selected from the order Diptera, more preferably from the families Tephritidae (in particular Ceratitis capitata as target) and Agromyzidae (in particular Liriomyza huidobrensis as target.

Further embodiment of the invention relates to a method of combating or controlling foliar insects selected from beetles from the order Coleoptera. Within this embodiment, preference is given to insects from the family Chrysomelidae, in particular Diabrotica speciosa as target.

Further embodiment of the invention relates to a method of combating or controlling foliar insects selected from thrips from the order of Thysanoptera. Within this embodiment, preference is given to insects from the family Thripidae, in particular Thrips tabaci as target.

Further embodiment of the invention relates to a method of combating or controlling foliar insects selected from true bugs from the order of Hemiptera. Within this embodiment, preference is given to insects from the families Aleyrodidae (in particular Whiteflies, Bemisia tabaci as target) and Aphididae (in particular Brevicoryne brassicae as target).

Further embodiment of the invention relates to a method of combating or controlling foliar insects selected from the order of Trombidiformes. Within this embodiment, preference is given to insects from the family Tenuipalpidae in particular Brevipalpus phoenicis as target.

Further embodiment of the invention relates to a method of combating or controlling mites selected from the order of Trombidiformes. Within this embodiment, preference is given to mites from the families Tetranychidae (in particular Tetranychus urticae and Panonychus ulmi as target), Tarsonemidae (in particular Polyphagotarsonemus latus as target). and Eriophyidae (in particular Phyllocoptruta oleivora as target).

The compositions according to the present invention are used to control said target pests and/or to protect the plants which include the agricultural plants, seeds, roots and/or the above-ground parts of field, forage, plantation, glasshouse, orchard or vineyard crops, ornamentals, plantation or forest trees and/or any other plant(s) of interest.

Particular embodiment of the invention relates to a method for treating and/or protecting plants from attack or infestation pests by insects, acarids or nematodes comprising applying the compositions according to the present invention to plant, or soil or water in which the plant is growing. Preferably, the compositions are applied to agricultural plants.

The term “agricultural plants” is to be understood as plants of which a part (e.g. seeds) or all is harvested or cultivated on a commercial scale or which serve as an important source of feed, food, fibres (e.g. cotton, linen), chemical processes (oil, sugar), combustibles (e.g. wood, bio ethanol, biodiesel, biomass) or other chemical compounds. Agricultural plants may also include trees (e.g. oak trees, pine trees) horticultural plants i.e. plants also growing in the garden such as plants grown for their ornamental uses e.g. flowers such as rose plants, or certain fruitsbearing plants e.g. apples plants, or vegetables plants e.g. tomato plants etc.

Preferred agricultural plants are for example

cereals plants, e.g. wheat, rye, barley, triticale, oats, sorghum or rice;
beet plants, e.g. sugar beet or fodder beet;
fruits bearing plants such as pomes, stone fruits or soft fruits, e.g. apples, melon, watermelon, papaya, passion fruits, pears, plums, apricots, prunes, peaches, almonds, cherries, strawberries, raspberries, blackberries or gooseberries;
citrus fruit plants such as oranges, lemons, grapefruits or mandarins;
leguminous plants such as drybeans, lentils, peas, alfalfa or soybeans;
oil plants, such as rape, oil-seed rape, canola, linseed, mustard, olives, sunflowers, coconut, cocoa beans, castor oil plants, oil palms, ground nuts or soybeans;
cucurbits plants such as squashes, cucumber or melons;
fibre plants, such as cotton, flax, hemp or jute;
vegetables plants such as spinach, lettuce, asparagus, cabbages, carrots, onions, tomatoes, potatoes, cucurbits or paprika;
lauraceous plants, such as avocados, cinnamon or camphor;
energy and raw material plants such as, soybean, rape, canola (oils seed rape), sugar cane or oil palm, corn, tobacco, nuts, coffee, tea, bananas,
vines such as table grapes, grape juice grape vines or pepper;
hop, turf, natural rubber plants or ornamental and forestry plants, such as flowers, shrubs, broad-leaved trees or evergreens (e.g. conifers) and
the plant propagation material, such as seeds, and the crop material of these plants.

Fruit bearing plants include the major types of fruit plants for example, berries such as grapes, blueberries; drupes such as peaches, cherries, olives, plums and walnuts; aggregate fruit such as blackberries and raspberries; multiple fruit such as pineapples, figs and mulberries; and fruit such as apples, pears and strawberries as well as citrus fruit such as oranges, grapefruit, kumquats, lemons, limes, tangerines, temples, citrange, tangelo, pomelo, and citron.

In the context of the present invention, the term “plant” refers to an entire plant, a part of the plant or the propagation material of the plant, such as the seed, the seed piece, the transplant, the seedling or the cutting.

An embodiment of the present invention relates to a method of treating and/or protecting plants from attack or infestation against pests, wherein the plant is a crop plant selected from fruit bearing plants, vegetables plants, cereals plants, raw material plants, leguminous plants and horticultural plants. Particular embodiments of the present invention relate to the methods of treating and/or protecting agricultural plants selected:

from fruit-bearing plants particularly such as citrus fruits, apples, apricots, cherries, peaches, prunes;
from vegetable plants particularly such as potato, tomato, cabbage;
from cereals plants particularly such as rice;
from leguminous plants particularly such as soybeans, drybeans;
from fibres plants particularly such as cotton;
from raw material plants particularly such as sugar cane, coffee, corn;
from horticultural plants particularly such as rose plants, chrysanthemum plants, azalea plants, begonia plants, camellia plants, lily plants, tulips;
from trees particularly such as oak trees, pine trees;

Plants treated with the composition according to the present invention include all genetically modified plants or transgenic plants, e.g. crops which tolerate the action of herbicides or fungicides or insecticides owing to breeding, including genetic engineering methods, or plants which have modified characteristics in comparison with existing plants, which can be generated for example by traditional breeding methods and/or the generation of mutants, or by recombinant procedures.

Some of the composition according to the present invention have systemic action and can therefore be used for the protection of the plant shoot against foliar pests as well as for the treatment of the seed and roots against soil pests. The term “seed treatment” comprises all suitable seed treatment techniques known in the art, such as seed dressing, seed coating, seed dusting, seed soaking and seed pelleting.

In particular, the seeds can be of tuberous and corm vegetables, such as arracacha, arrowroot, artichoke, canna, cassava, carrot, chayote root, chufa, dasheen, ginger, leren, onion, potato, radish, tanier, turmeric, yam bean, true yam; leafy vegetables, such as amaranth, arugula, cardoon, celery, celtuce, chervil, chrysanthemum, cress, dandelion, dock, endive, fennel, kale, leek, lettuce, orach, parsley, purslane, radicchio, rhubarb, spinach, swiss chard, tampala, head and stem brassica, such as broccoli, brussels sprout, cabbage, cauliflower, cavalo broccolo, curly cale, kohlrabi; leafy brassica greens, such as broccoli raab, cabbage, collards, kale, mizuna, mustard greens, mustard spinach, rape greens; fruiting vegetables such as beans, chili, postharvest, eggplant, groundcherry, pepino, pea, pepper, tomatillo, tomato. It is preferred that the seed be broccoli, carrot, cabbage, especially chinese cabbage, red cabbage, savoy cabbage, white cabbage, celery, cauliflower, kohlrabi and radish seeds

An embodiment of the invention relates to a method for protecting or treating fruit bearing plants against their commonly infesting pests such as Lymantriidae family, e.g. Euproctis, Lasiocampidae family e.g. Malocosoma, family comprising the application of the composition according to the invention to the fruit plant.

A further embodiment of the invention relates to a method for protecting or treating apples plants against their commonly infesting pests such as the Tetranychidae family, e.g. Panonychus ulmi comprising the application of the composition according to the invention to the apple plant.

A further embodiment of the invention relates to a method for protecting or treating citrus fruits plants against their commonly infesting pests such as the Tenuipalpidae family e.g. Brevipalpus phoenicis, the Eriophyidae family, e.g. Phyllocoptruta oleivora and the Tarsonemidae spp. family, e.g. Polyphagotarsonemus latus comprising the application of the composition according to the invention to the citrus fruit plant.

An embodiment of the invention relates to a method for protecting or treating vegetable plants from their commonly infesting pests such as the Chrysomelidae family, the Agromyzidae family, the Gelechiidae family, the Pieridae family, the Tetranychidae spp. family, the Thripidae family, Solanaceae family comprising the application of the composition according to the invention to the vegetable plant.

A further embodiment of the invention relates to a method for protecting or treating potato plants against their commonly infesting pests such as the Chrysomelidae family, e.g. Diabrotica speciosa, the Agromyzidae family, e.g. Liriomyza huidobrensis, the Gelechiidae family, e.g. Phthorimaea operculella and the Thripidae family, e.g. Thrips tabaci comprising the application of the composition according to the invention to the potato plant.

A further embodiment of the invention relates to a method for protecting or treating tomato plants against their commonly infesting pests such as mite, particularly mites from the Solanaceae family e.g. Aculops lycopersici, the Tetranychidae spp. family e.g. Tetranychus urticae and Tuta absoluta comprising the application of the composition according to the invention to the tomato plant.

A further embodiment of the invention relates to a method for protecting cabbage plants against their commonly infesting pests such as the Pieridae family, e.g. Ascia monuste orseis, the Agromyzidae family, e.g. Liriomyza huidobrensis comprising the application of the composition according to the invention to the cabbage plant.

An embodiment of the invention relates to a method for protecting or treating cereal plants against their commonly infesting pests such as the larvae of the coleoptera order comprising the application of the composition according to the invention to the cereal plant.

A further embodiment of the invention relates to a method for protecting or treating rice plants against their commonly infesting pests such as the larvae of the coleoptera order comprising the application of the composition according to the invention to the rice plant.

A further embodiment of the invention relates to a method for protecting or treating sugar cane plants against their commonly infesting pests such as the noctuidae family, e.g. Alabama Argillacea comprising the application of the composition according to the invention to the sugar cane plant.

A further embodiment of the invention relates to a method for protecting or treating coffee plants against their commonly infesting pests such as the Tenuipalpidae family e.g. Brevipalpus phoenicis comprising the application of the composition according to the invention to the coffee plant.

A further embodiment of the invention relates to a method for protecting or treating corn plants against their commonly infesting pests such as the Noctuidae family, e.g. Spodoptera frugiperda comprising the application of the composition according to the invention to the corn plant.

A further embodiment of the invention relates to a method for protecting or treating soybean plants against their commonly infesting pests such as the Noctuidae family, e.g. Anticarsia gemmatalis and Pseudoplusia includens, the Tetranychidae spp. family, e.g. Tetranychus urticae, and the Tarsonemidae spp. family, e.g. Polyphagotarsonemus latus comprising the application of the composition according to the invention to the soybean plant.

A further embodiment of the invention relates to a method for protecting or treating drybean plants against their commonly infesting pests such as the Chrysomelidae family, e.g. Diabrotica speciosa, the Thripidae family, e.g. Thrips tabaci, the Tetranychidae spp. family e.g. Tetranychus urticae and the Aleyrodidae family, e.g. Bemisia tabaci, comprising the application of the composition according to the invention to the drybean plant.

An embodiment of the invention relates to a method for protecting or treating horticultural plants against their commonly infesting pests such as the leafminers, the Heterocera, e.g. cutworms, the Aleyrodidae family, e.g. whiteflies, sciara spp. comprising the application of the composition according to the invention to the horticultural plant.

A further embodiment of the invention relates to a method for protecting or treating chrisantemum plants against their commonly infesting pests such as the Thripidae family, e.g Thrips tabaci and the Tetranychidae spp. family, e.g. Tetranychus urticae, comprising the application of the composition according to the invention to the Chrisantemum plant.

A further embodiment of the invention relates to a method for protecting or treating rose plants against their commonly infesting pests such as the Tetranychidae spp. family, e.g. Tetranychus urticae comprising the application of the composition of the present invention to the rose plant.

As said above, the present invention comprises a method for controlling pests, that means animal pests as above described and/or harmful fungi, wherein the pest, their habitat, breeding grounds, their locus or the plants to be protected against pest attack, the soil or plant propagation material (preferably seed) are treated with an pesticidally effective amount of a composition according to the invention.

When a fungicidal pesticidal active component is present in the compositions according to the present invention, said compositions are particularly important for controlling and/or treating against the commonly infesting fungal pests on various cultivated plants, such as bananas, cotton, vegetable species (for example cucumbers, beans and cucurbits), cereals such as wheat, rye, barley, rice, oats; grass coffee, potatoes, corn, fruit species, soya, tomatoes, grapevines, ornamental plants, sugar cane and also on a large number of seeds. In a preferred embodiment, the inventive mixtures are used in soya (soybean), cereals and corn.

Advantageously, the inventive compositions are suitable for controlling the following fungal plant diseases:

Albugo spp. (white rust) on ornamentals, vegetables (e.g. A. candida) and sunflowers (e.g. A. tragopogonis); Alternaria spp. (Alternaria leaf spot) on vegetables, rape (A. brassicola or brassicae), sugar beets (A. tenuis), fruits, rice, soybeans, potatoes (e.g. A. solani or A. alternata), tomatoes (e.g. A. solani or A. alternata) and wheat; Aphanomyces spp. on sugar beets and vegetables; Ascochyta spp. on cereals and vegetables, e.g. A. tritici (anthracnose) on wheat and A. hordei on barley; Bipolaris and Drechslera spp. (teleomorph: Cochliobolus spp.), e.g. Southern leaf blight (D. maydis) or Northern leaf blight (B. zeicola) on corn, e.g. spot blotch (B. sorokinlana) on cereals and e.g. B. oryzae on rice and turfs; Blumeria (formerly Erysiphe) graminis (powdery mildew) on cereals (e.g. on wheat or barley); Botrytis cinerea (teleomorph: Botryotinia fuckeliana: grey mold) on fruits and berries (e.g. strawberries), vegetables (e.g. lettuce, carrots, celery and cabbages), rape, flowers, vines, forestry plants and wheat; Bremia lactucae (downy mildew) on lettuce; Ceratocystis (syn. Ophiostoma) spp. (rot or wilt) on broad-leaved trees and evergreens, e.g. C. ulmi (Dutch elm disease) on elms; Cercospora spp. (Cercospora leaf spots) on corn (e.g. Gray leaf spot: C. zeae-maydis), rice, sugar beets (e.g. C. beticola), sugar cane, vegetables, coffee, soybeans (e.g. C. sojina or C. kikuchii) and rice; Cladosporium spp. on tomatoes (e.g. C. fulvum: leaf mold) and cereals, e.g. C. herbarum (black ear) on wheat; Claviceps purpurea (ergot) on cereals; Cochliobolus (anamorph: Helminthosporium of Bipolaris) spp. (leaf spots) on corn (C. carbonum), cereals (e.g. C. sativus, anamorph: B. sorokiniana) and rice (e.g. C. miyabeanus, anamorph: H. oryzae); Colletotrichum (teleomorph: Glomerella) spp. (anthracnose) on cotton (e.g. C. gossypii), corn (e.g. C. graminicola: Anthracnose stalk rot), soft fruits, potatoes (e.g. C. coccodes: black dot), beans (e.g. C. lindemuthianum) and soybeans (e.g. C. truncatum or C. gloeosporioides); Corticium spp., e.g. C. sasakii (sheath blight) on rice; Corynespora cassiicola (leaf spots) on soybeans and ornamentals; Cycloconium spp., e.g. C. oleaginum on olive trees; Cylindrocarpon spp. (e.g. fruit tree canker or young vine decline, teleomorph: Nectria or Neonectria spp.) on fruit trees, vines (e.g. C. liriodendri, teleomorph: Neonectria liriodendri: Black Foot Disease) and ornamentals; Dematophora (teleomorph: Rosellinia) necatrix (root and stem rot) on soybeans; Diaporthe spp., e.g. D. phaseolorum (damping off) on soybeans; Drechslera (syn. Helminthosporium, teleomorph: Pyrenophora) spp. on corn, cereals, such as barley (e.g. D. teres, net blotch) and wheat (e.g. D. tritici-repentis: tan spot), rice and turf; Esca (dieback, apoplexy) on vines, caused by Formitiporia (syn. Phellinus) punctata, F. mediterranea, Phaeomoniella chlamydospora (earlier Phaeoacremonium chlamydosporum), Phaeoacremonium aleophilum and/or Botryosphaeria obtusa; Elsinoe spp. on pome fruits (E. pyri), soft fruits (E. veneta: anthracnose) and vines (E. ampelina: anthracnose); Entyloma oryzae (leaf smut) on rice; Epicoccum spp. (black mold) on wheat; Erysiphe spp. (powdery mildew) on sugar beets (E. betae), vegetables (e.g. E. pisi), such as cucurbits (e.g. E. cichoracearum), cabbages, rape (e.g. E. cruciferarum); Eutypa lata (Eutypa canker or dieback, anamorph: Cytosporina lata, syn. Libertella blepharis) on fruit trees, vines and ornamental woods; Exserohilum (syn. Helminthosporium) spp. on corn (e.g. E. turcicum); Fusarium (teleomorph: Gibberella) spp. (wilt, root or stem rot) on various plants, such as F. graminearum or F. culmorum (root rot, scab or head blight) on cereals (e.g. wheat or barley), F. oxysporum on tomatoes, F. solani on soybeans and F. verticillioides on corn; Gaeumannomyces graminis (take-all) on cereals (e.g. wheat or barley) and corn; Gibberella spp. on cereals (e.g. G. zeae) and rice (e.g. G. fujikuroi: Bakanae disease); Glomerella cingulata on vines, pome fruits and other plants and G. gossypii on cotton; Grainstaining complex on rice; Guignardia bidwellii (black rot) on vines; Gymnosporangium spp. on rosaceous plants and junipers, e.g. G. sabinae (rust) on pears; Helminthosporium spp. (syn. Drechslera, teleomorph: Cochliobolus) on corn, cereals and rice; Hemileia spp., e.g. H. vastatrix (coffee leaf rust) on coffee; Isariopsis clavispora (syn. Cladosporium vitis) on vines; Macrophomina phaseolina (syn. phaseoli) (root and stem rot) on soybeans and cotton; Microdochium (syn. Fusarium) nivale (pink snow mold) on cereals (e.g. wheat or barley); Microsphaera diffusa (powdery mildew) on soybeans; Monilinia spp., e.g. M. laxa, M. fructicola and M. fructigena (bloom and twig blight, brown rot) on stone fruits and other rosaceous plants; Mycosphaerella spp. on cereals, bananas, soft fruits and ground nuts, such as e.g. M. graminicola (anamorph: Septoria tritici, Septoria blotch) on wheat or M. fijiensis (black Sigatoka disease) on bananas; Peronospora spp. (downy mildew) on cabbage (e.g. P. brassicae), rape (e.g. P. parasitica), onions (e.g. P. destructor), tobacco (P. tabacina) and soybeans (e.g. P. manshurica); Phakopsora pachyrhizi and P. meibomiae (soybean rust) on soybeans; Phialophora spp. e.g. on vines (e.g. P. tracheiphila and P. tetraspora) and soybeans (e.g. P. gregata: stem rot); Phoma lingam (root and stem rot) on rape and cabbage and P. betae (root rot, leaf spot and damping-off) on sugar beets; Phomopsis spp. on sunflowers, vines (e.g. P. viticola: can and leaf spot) and soybeans (e.g. stem rot: P. phaseoli, teleomorph: Diaporthe phaseolorum); Physoderma maydis (brown spots) on corn; Phytophthora spp. (wilt, root, leaf, fruit and stem root) on various plants, such as paprika and cucurbits (e.g. P. capsici), soybeans (e.g. P. megasperma, syn. P. sojae), potatoes and tomatoes (e.g. P. infestans: late blight) and broad-leaved trees (e.g. P. ramorum: sudden oak death); Plasmodiophora brassicae (club root) on cabbage, rape, radish and other plants; Plasmopara spp., e.g. P. viticola (grapevine downy mildew) on vines and P. halstedii on sunflowers; Podosphaera spp. (powdery mildew) on rosaceous plants, hop, pome and soft fruits, e.g. P. leucotricha on apples; Polymyxa spp., e.g. on cereals, such as barley and wheat (P. graminis) and sugar beets (P. betae) and thereby transmitted viral diseases; Pseudocercosporella herpotrichoides (eyespot, teleomorph: Tapesia yallundae) on cereals, e.g. wheat or barley; Pseudoperonospora (downy mildew) on various plants, e.g. P. cubensis on cucurbits or P. humili on hop; Pseudopezicula tracheiphila (red fire disease or ‘rotbrenner’, anamorph: Phialophora) on vines; Puccinia spp. (rusts) on various plants, e.g. P. triticina (brown or leaf rust), P. striiformis (stripe or yellow rust), P. hordei (dwarf rust), P. graminis (stem or black rust) or P. recondita (brown or leaf rust) on cereals, such as e.g. wheat, barley or rye, P. kuehnii (orange rust) on sugar cane and P. asparagi on asparagus; Pyrenophora (anamorph: Drechslera) tritici-repentis (tan spot) on wheat or P. teres (net blotch) on barley; Pyricularia spp., e.g. P. oryzae (teleomorph: Magnaporthe grisea, rice blast) on rice and P. grisea on turf and cereals; Pythium spp. (damping-off) on turf, rice, corn, wheat, cotton, rape, sunflowers, soybeans, sugar beets, vegetables and various other plants (e.g. P. ultimum or P. aphanidermatum); Ramularia spp., e.g. R. collo-cygni (Ramularia leaf spots, Physiological leaf spots) on barley and R. beticola on sugar beets; Rhizoctonia spp. on cotton, rice, potatoes, turf, corn, rape, potatoes, sugar beets, vegetables and various other plants, e.g. R. solani (root and stem rot) on soybeans, R. solani (sheath blight) on rice or R. cerealis (Rhizoctonia spring blight) on wheat or barley; Rhizopus stolonifer (black mold, soft rot) on strawberries, carrots, cabbage, vines and tomatoes; Rhynchosporium secalis (scald) on barley, rye and triticale; Sarocladium oryzae and S. attenuatum (sheath rot) on rice; Sclerotinia spp. (stem rot or white mold) on vegetables and field crops, such as rape, sunflowers (e.g. S. sclerotiorum) and soybeans (e.g. S. rolfsii or S. sclerotiorum); Septoria spp. on various plants, e.g. S. glycines (brown spot) on soybeans, S. tritici (Septoria blotch) on wheat and S. (syn. Stagonospora) nodorum (Stagonospora blotch) on cereals; Uncinula (syn. Erysiphe) necator (powdery mildew, anamorph: Oidium tuckeri) on vines; Setospaeria spp. (leaf blight) on corn (e.g. S. turcicum, syn. Helminthosporium turcicum) and turf; Sphacelotheca spp. (smut) on corn, (e.g. S. reiliana: head smut), sorghum and sugar cane; Sphaerotheca fuliginea (powdery mildew) on cucurbits; Spongospora subterranea (powdery scab) on potatoes and thereby transmitted viral diseases; Stagonospora spp. on cereals, e.g. S. nodorum (Stagonospora blotch, teleomorph: Leptosphaeria [syn. Phaeosphaeria] nodorum) on wheat; Synchytrium endobioticum on potatoes (potato wart disease); Taphrina spp., e.g. T. deformans (leaf curl disease) on peaches and T. pruni (plum pocket) on plums; Thielaviopsis spp. (black root rot) on tobacco, pome fruits, vegetables, soybeans and cotton, e.g. T. basicola (syn. Chalara elegans); Tilletia spp. (common bunt or stinking smut) on cereals, such as e.g. T. tritici (syn. T. caries, wheat bunt) and T. controversa (dwarf bunt) on wheat; Typhula incarnata (grey snow mold) on barley or wheat; Urocystis spp., e.g. U. occulta (stem smut) on rye; Uromyces spp. (rust) on vegetables, such as beans (e.g. U. appendiculatus, syn. U. phaseoli) and sugar beets (e.g. U. betae); Ustilago spp. (loose smut) on cereals (e.g. U. nuda and U. avaenae), corn (e.g. U. maydis: corn smut) and sugar cane; Venturia spp. (scab) on apples (e.g. V. inaequalis) and pears; and Verticillium spp. (wilt) on various plants, such as fruits and ornamentals, vines, soft fruits, vegetables and field crops, e.g. V. dahliae on strawberries, rape, potatoes and tomatoes.

The present mixtures i.e the combinations of the actives pesticidal compounds according to the present invention and compositions thereof, respectively, are also suitable for controlling harmful fungi in the protection of stored products or harvest and in the protection of materials. The term “protection of materials” is to be understood to denote the protection of technical and non-living materials, such as adhesives, glues, wood, paper and paperboard, textiles, leather, paint dispersions, plastics, coiling lubricants, fiber or fabrics, against the infestation and destruction by harmful microorganisms, such as fungi and bacteria. As to the protection of wood and other materials, the particular attention is paid to the following harmful fungi: Ascomycetes such as Ophiostoma spp., Ceratocystis spp., Aureobasidium pullulans, Sclerophoma spp., Chaetomium spp., Humicola spp., Petriella spp., Trichurus spp.; Basidiomycetes such as Coniophora spp., Coriolus spp., Gloeophyllum spp., Lentinus spp., Pleurotus spp., Poria spp., Serpula spp. and Tyromyces spp., Deuteromycetes such as Aspergillus spp., Cladosporium spp., Penicillium spp., Trichorma spp., Alternaria spp., Paecilomyces spp. and Zygomycetes such as Mucor spp., and in addition in the protection of stored products and harvest the following yeast fungi are worthy of note: Candida spp. and Saccharomyces cerevisae.

For use according to the present invention, the inventive composition or the combination of the active compounds (I), (II) and (III) can be converted into customary formulations, for example solutions, emulsions, suspensions, dusts, powders, pastes and granules. The use form depends on the particular intended purpose; in each case, it should ensure a fine and even distribution of the compound according to the invention.

All above-referred compositions according to the present invention are herein below referred to as “inventive mixtures” or “mixtures according to the present invention.

The inventive mixtures can be converted into customary types of agrochemical compositions, e.g. solutions, emulsions, suspensions, dusts, powders, pastes, granules, pressings, capsules, and mixtures thereof. Examples for composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further compositions types are defined in the “Catalogue of pesticide formulation types and international coding system”, Technical Monograph No. 2, 6^{th} Ed. May 2008, CropLife International.

The compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005. Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders. Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e.g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emusifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a negligible or even no pesticidal activity themselves, and which improve the biological performance of the inventive mixtures on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

Examples for composition types and their preparation are:

i) Water-soluble concentrates (SL, LS)

10-60 wt % of an inventive mixture and 5-15 wt % wetting agent (e.g. alcohol alkoxylates) are dissolved in water and/or in a water-soluble solvent (e.g. alcohols) ad 100 wt %. The active substance dissolves upon dilution with water.

ii) Dispersible concentrates (DC)

5-25 wt % of an inventive mixture and 1-10 wt % dispersant (e.g. polyvinylpyrrolidone) are dissolved in organic solvent (e.g. cyclohexanone) ad 100 wt %. Dilution with water gives a dispersion.

iii) Emulsifiable concentrates (EC)

15-70 wt % of an inventive mixture and 5-10 wt % emulsifiers (e.g. calcium dodecylbenzenesulfonate and castor oil ethoxylate) are dissolved in water-insoluble organic solvent (e.g. aromatic hydrocarbon) ad 100 wt %. Dilution with water gives an emulsion.

### iv) Emulsions (EW, EO, ES)

5-40 wt % of an inventive mixture and 1-10 wt % emulsifiers (e.g. calcium dodecylbenzenesulfonate and castor oil ethoxylate) are dissolved in 20-40 wt % water-insoluble organic solvent (e.g. aromatic hydrocarbon). This mixture is introduced into water ad 100 wt % by means of an emulsifying machine and made into a homogeneous emulsion. Dilution with water gives an emulsion.

### v) Suspensions (SC, OD, FS)

In an agitated ball mill, 20-60 wt % of an inventive mixture are comminuted with addition of 2-10 wt % dispersants and wetting agents (e.g. sodium lignosulfonate and alcohol ethoxylate), 0.1-2 wt % thickener (e.g. xanthan gum) and water ad 100 wt % to give a fine active substance suspension. Dilution with water gives a stable suspension of the active substance. For FS type composition up to 40 wt % binder (e.g. polyvinylalcohol) is added.

vi) Water-dispersible granules and water-soluble granules (WG, SG)

50-80 wt % of an inventive mixture are ground finely with addition of dispersants and wetting agents (e.g. sodium lignosulfonate and alcohol ethoxylate) ad 100 wt % and prepared as water-dispersible or water-soluble granules by means of technical appliances (e.g. extrusion, spray tower, fluidized bed). Dilution with water gives a stable dispersion or solution of the active substance.

vii) Water-dispersible powders and water-soluble powders (WP, SP, WS)

50-80 wt % of an inventive mixture are ground in a rotor-stator mill with addition of 1-5 wt % dispersants (e.g. sodium lignosulfonate), 1-3 wt % wetting agents (e.g. alcohol ethoxylate) and solid carrier (e.g. silica gel) ad 100 wt %. Dilution with water gives a stable dispersion or solution of the active substance.

viii) Gel (GW, GF)

In an agitated ball mill, 5-25 wt % of an inventive mixture are comminuted with addition of 3-10 wt % dispersants (e.g. sodium lignosulfonate), 1-5 wt % thickener (e.g. carboxymethylcellulose) and water ad 100 wt % to give a fine suspension of the active substance. Dilution with water gives a stable suspension of the active substance.

### iv) Microemulsion (ME)

5-20 wt % of an inventive mixture are added to 5-30 wt % organic solvent blend (e.g. fatty acid dimethylamide and cyclohexanone), 10-25 wt % surfactant blend (e.g. alcohol ethoxylate and arylphenol ethoxylate), and water ad 100%. This mixture is stirred for 1 h to produce spontaneously a thermodynamically stable microemulsion.

### iv) Microcapsules (CS)

An oil phase comprising 5-50 wt % of an inventive mixture, 0-40 wt % water insoluble organic solvent (e.g. aromatic hydrocarbon), 2-15 wt % acrylic monomers (e.g. methylmethacrylate, methacrylic acid and a di- or triacrylate) are dispersed into an aqueous solution of a protective colloid (e.g. polyvinyl alcohol). Radical polymerization initiated by a radical initiator results in the formation of poly(meth)acrylate microcapsules. Alternatively, an oil phase comprising 5-50 wt % of an inventive mixture according to the invention, 0-40 wt % water insoluble organic solvent (e.g. aromatic hydrocarbon), and an isocyanate monomer (e.g. diphenylmethene-4,4′-diisocyanatae) are dispersed into an aqueous solution of a protective colloid (e.g. polyvinyl alcohol). The addition of a polyamine (e.g. hexamethylenediamine) results in the formation of polyurea microcapsules. The monomers amount to 1-10 wt %. The wt % relate to the total CS composition.

ix) Dustable powders (DP, DS)

1-10 wt % of an inventive mixture are ground finely and mixed intimately with solid carrier (e.g. finely divided kaolin) ad 100 wt %.

### x) Granules (GR, FG)

0.5-30 wt % of an inventive mixture is ground finely and associated with solid carrier (e.g. silicate) ad 100 wt %. Granulation is achieved by extrusion, spray-drying or fluidized bed.

xi) Ultra-low volume liquids (UL)

1-50 wt % of an inventive mixture are dissolved in organic solvent (e.g. aromatic hydrocarbon) ad 100 wt %.

The compositions types i) to xi) may optionally comprise further auxiliaries, such as 0.1-1 wt % bactericides, 5-15 wt % anti-freezing agents, 0.1-1 wt % anti-foaming agents, and 0.1-1 wt % colorants.

The resulting agrochemical compositions generally comprise between 0.01 and 95%, preferably between 0.1 and 90%, and in particular between 0.5 and 75%, by weight of active substance. The active substances are employed in a purity of from 90% to 100%, preferably from 95% to 100% (according to NMR spectrum).

Solutions for seed treatment (LS), Suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds. The compositions in question give, after two-to-tenfold dilution, active substance concentrations of from 0.01 to 60% by weight, preferably from 0.1 to 40%, in the ready-to-use preparations. Application can be carried out before or during sowing. Methods for applying the inventive mixtures and compositions thereof, respectively, on to plant propagation material, especially seeds include dressing, coating, pelleting, dusting, soaking and in-furrow application methods of the propagation material. Preferably, the inventive mixtures or the compositions thereof, respectively, are applied on to the plant propagation material by a method such that germination is not induced, e.g. by seed dressing, pelleting, coating and dusting.

When employed in plant protection, the amounts of active substances applied are, depending on the kind of effect desired, from 0.001 to 2 kg per ha, preferably from 0.005 to 2 kg per ha, more preferably from 0.01 to 1.0 kg per ha, and in particular from 0.05 to 0.75 kg per ha.

In treatment of plant propagation materials such as seeds, e.g. by dusting, coating or drenching seed, amounts of active substance of from 0.01-10 kg, preferably from 0.1-1000 g, more preferably from 1-100 g per 100 kilogram of plant propagation material (preferably seeds) are generally required.

When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

Various types of oils, wetters, adjuvants, fertilizer, or micronutrients, and further pesticides (e.g. herbicides, insecticides, fungicides, growth regulators, safeners) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

According to one embodiment, individual components of the composition according to the invention such as parts of a kit or parts of a binary or ternary mixture may be mixed by the user himself in a spray tank and further auxiliaries may be added, if appropriate.

In a further embodiment, either individual compounds of the inventive mixtures formulated as composition or partially premixed components, e.g. components set forth in the inventive mixtures may be mixed by the user in a spray tank and further auxiliaries and additives may be added, if appropriate (tank mix).

In a further embodiment, either individual components of the composition according to the invention or partially premixed components, e.g. components comprising the compound (I), (II) and (III), can be applied jointly (e.g. after tankmix) or consecutively.

Compositions of this invention may also contain other active ingredients, for example other pesticides which may be insecticides, fungicides, herbicides, fertilizers such as ammonium nitrate, urea, potash, and superphosphate, phytotoxicants and plant growth regulators, safeners and nematicides. These additional ingredients may be used sequentially or in combination with the above-described compositions, if appropriate also added only immediately prior to use (tank mix). These agents can be admixed with the mixtures according to the invention in a weight ratio of 1:10 to 10:1. For example, the plant(s) may be sprayed with a composition of this invention either before or after being treated with other active ingredients.

The compositions and methods according to the invention are particularly useful for the control of pests. The compositions and methods according to the present invention are particularly useful for combating animal pests.

The methods of controlling and/or combating animal pests comprise treating, that is to say contacting the animal pests with, their habitat, breeding ground, food supply, cultivated plants, seed, soil, area, material or environment in which the animal pests are growing or may grow, or the materials, the plants seeds, soils, surfaces or spaces to be protected from animal attack or infestation with a pesticidally effective amount of a mixture of at least one active compound of formula (I), (II) and optionally a further compound (III).

The pesticidal compositions according to the present invention are suitable for efficiently controlling invertebrate pests, particularly, insects, acarids and nematodes. They can be applied to any and all developmental stages, such as egg, larva, pupa, and adult.

The pests may be controlled by contacting the pest itself, its food supply, habitat, breeding ground or its locus with a pesticidally effective amount of the inventive mixtures or of compositions comprising the active compounds (I), (II) and optionally (III).

The term “locus” in the present invention means a plant, seed, soil, area, material or environment in which a pest is growing or may grow.

In general, “pesticidally effective amount” means the amount of the compositions comprising the active compounds according to the invention needed to achieve an observable effect on growth, including the effects of necrosis, death, retardation, prevention, and removal, destruction, or otherwise diminishing the occurrence and activity of the target organism. The pesticidally effective amount can vary for the various mixtures/compositions used in the invention. A pesticidally effective amount of the mixtures/compositions will also vary according to the prevailing conditions such as desired pesticidal effect and duration, weather, target species, locus, mode of application, and the like.

Whenever used in the present invention, the term pesticidally effective amounts in accordance with the present invention always refers to a synergistically effective amount of the compounds (I), (II) and optionally (III) in the ratio as above defined.

It will be appreciated from the above, that the compounds (I), (II) and optionally (III) can be applied simultaneously, that is jointly (e.g. in the same formulation) or separately (e.g. in different formulations, such as in kit form), or in succession. If there is a successive application, it will also be appreciated that the subsequently applied compounds (I), (II) and optionally (III) should be applied to a subject (e.g. the pest, plant or animal) within a time scale so as to achieve or optimize the above referred to advantageous synergistic effect.

Depending on the desired effect, the application rates of the mixtures according to the invention are from 1 to 2500 g/ha, preferably from 5 to 2000 g/ha, more preferably from 50 to 1500 g/ha, in particular from 50 to 750 g/ha, even more particularly from 5 to 500 g/ha. For use in treating agricultural plants, the rate of application of the composition with the active compounds (I), (II) and optionally (III) according to the present invention may be in the range of 0.1 g to 4000 g per hectare, desirably from 25 g to 600 g per hectare, more desirably from 50 g to 500 g per hectare.

The compositions according to the invention are also suitable for the protection of the seed and the seedlings' roots and shoots, against soil pests.

The inventive composition are effective through both contact (via soil, glass, wall, bed net, carpet, plant parts or animal parts), and ingestion (bait, or plant part) and through trophallaxis and transfer.

The compositions according to the present invention are preferably effective through foliar contact for the protection of plants.

According to a further embodiment of the invention, the pesticidal compositions are employed via soil application. Soil application is especially favorable for use against ants, termites, flies, crickets, grubs, root weevils, root beetles or nematodes.

The compositions according to the invention can be used for protecting wooden materials such as trees, board fences, sleepers, etc. and buildings such as houses, outhouses, factories, but also construction materials, furniture, leathers, fibers, vinyl articles, electric wires and cables etc. from ants and/or termites, and for controlling ants and termites from doing harm to crops or human being (e.g. when the pests invade into houses and public facilities). The compositions according to the present invention are applied not only to the surrounding soil surface or into the under-floor soil in order to protect wooden materials but it can also be applied to lumbered articles such as surfaces of the under-floor concrete, alcove posts, beams, polywoods, furniture, etc., wooden articles such as particle boards, half boards, etc. and vinyl articles such as coated electric wires, vinyl sheets, heat insulating material such as styrene foams, etc. In case of application against ants doing harm to crops or human beings, the ant control composition of the present invention is directly applied to the nest of the ants or to its surrounding or via bait contact.

The mixture of compounds (I), (II) and optionally (III) for the compositions according to the invention can also be applied preventively to places at which occurrence of the pests is expected. In the case of soil treatment or of application to the pests dwelling place or nest, the quantity of the composition with the active compounds in ranges from 0.0001 to 500 g per 100 m², preferably from 0.001 to 20 g per 100 m².

Customary application rates in the protection of materials are, for example, from 0.01 g to 1000 g of the composition of the active compounds per m² treated material, desirably from 0.1 g to 50 g per m².

Insecticidal compositions for use in the impregnation of materials typically contain from 0.001 to 95 weight %, preferably from 0.1 to 45 weight %, and more preferably from 1 to 25 weight % of the composition with the active compounds.

For use in bait compositions, the typical content of the composition with the active compounds (I), (II) and optionally (III) is from 0.0001 weight % to 15 weight %, desirably from 0.001 weight % to 5% weight % of active compounds. The composition used may also comprise other additives such as a solvent of the active materials, a flavoring agent, a preserving agent, a dye or a bitter agent. Its attractiveness may also be enhanced by a special color, shape or texture. For use in spray compositions, the content of the composition with the active compounds (I), (II) and optionally (III) is from 0.001 to 80 weights %, preferably from 0.01 to 50 weight % and most preferably from 0.01 to 15 weight %.

It was also an object of the present invention to provide composition suitable for treating, controlling, preventing and protecting warm-blooded animals, including humans, and fish against infestation and infection by pests. Problems that may be encountered with pest control on or in animals and/or humans are similar to those described at the outset, namely the need for reduced dosage rates, and/or enhanced spectrum of activity and/or combination of knock-down activity with prolonged control and/or resistance management.

This invention also provides a method for treating, controlling, preventing and protecting warm-blooded animals, including humans, and fish against infestation and infection by pests of the orders Siphonaptera, Hymenoptera, Hemiptera, Orthoptera, Acarina, Phthiraptera, and Diptera, which comprises orally, topically or parenterally administering or applying to said animals a pesticidally effective amount of mixtures according to the invention.

The invention also provides a process for the preparation of a composition for treating, controlling, preventing or protecting a warm-blooded animal or a fish against infestation or infection by pests of the Siphonaptera, Hymenoptera, Hemiptera, Orthoptera, Acarina, Phthiraptera, and Diptera orders which comprises a pesticidally effective amount of a mixture according to the invention.

The above method is particularly useful for controlling and preventing infestations and infections in warm-blooded animals such as cattle, sheep, swine, camels, deer, horses, poultry, goats, dogs and cats as well as humans.

Infestations in warm-blooded animals and fish including, but not limited to, lice, biting lice, ticks, nasal bots, keds, biting flies, muscoid flies, flies, myiasitic fly larvae, chiggers, gnats, mosquitoes and fleas may be controlled, prevented or eliminated by the mixtures according to the invention.

For oral administration to warm-blooded animals, the composition according to the invention may be formulated as animal feeds, animal feed premixes, animal feed concentrates, pills, solutions, pastes, suspensions, drenches, gels, tablets, boluses and capsules. In addition, the mixtures according to the invention may be administered to the animals in their drinking water. For oral administration, the dosage form chosen should provide the animal with 0.01 mg/kg to 100 mg/kg of animal body weight per day of the mixture.

Alternatively, the composition according to the invention may be administered to animals parenterally, for example, by intraruminal, intramuscular, intravenous or subcutaneous injection. The mixtures according to the invention may be dispersed or dissolved in a physiologically acceptable carrier for subcutaneous injection. Alternatively, the compositions according to the invention may be formulated into an implant for subcutaneous administration. In addition the compositions according to the invention may be transdermally administered to animals. For parenteral administration, the dosage form chosen should provide the animal with 0.01 mg/kg to 100 mg/kg of animal body weight per day of the composition.

The compositions according to the invention may also be applied topically to the animals in the form of dips, dusts, powders, collars, medallions, sprays, spot-on and pour-on formulations. For topical application, dips and sprays usually contain 0.5 ppm to 5,000 ppm and preferably 1 ppm to 3,000 ppm of the inventive compounds. In addition, the compositions according to the invention may be formulated as ear tags for animals, particularly quadrupeds such as cattle and sheep.

Accordingly, in a further aspect of the invention there is provided the use of a composition according to the invention in the preparation of a veterinary medicament, specifically an antiparasiticidal medicament.

Colby's formula may be applied to determine whether the composition showed synergistic α-tion: S. R. Colby (1967) “Calculating synergistic and antagonistic responses of herbicide combinations”, Weeds 15, p. 22

E=X+Y−(XY/100)

where

X=effect in percent using pesticidal compound A at an application rate a;

Y=effect in percent using pesticidal compound B at application rate b;

E=expected effect (in %) of pesticidal compounds A+B at application rates a+b.

For mixtures of three individual pesticidal compounds a modified Colby formula can be used:

E=X+Y+Z−[(X·Y+X·Z+Y·Z)/100]−X·Z·Y·Z/10000

where E, X and Y are as defined above and Z is the pesticidal effect in percent using the pesticidal compound C at an application rate c.

The value E calculated according to the above Colby formula corresponds to the pesticidal effect (insecticidal/fungicidal) which is to be expected if the activity of the individual compounds is just additive. If the observed effect is higher than the value E calculated according to Colby, a synergistic effect is present.

For mixtures of three individual compounds (I), (II), and (III) a modified Colby formula can be used:

E′=X+Y+Z−[(X·Y+X·Z+Y·Z)/100]−X·Z·Y·Z/10000

where
X and Y are as defined above, and
Z is the pesticidal effect in percent using the pesticidal compound C at an application rate c, and
E′ is expected effect (in %) of pesticidal compounds A+B+C at application rates a+b+c.

The value E′ calculated according to modified Colby formula corresponds to the effect (insecticidal/fungicidal) which is to be expected if the activity of the individual compounds is just additive. If the observed effect is higher than the value E′ calculated according to Colby, a synergistic effect is present.

1-16. (canceled)

17. A pesticidal composition comprising, as active components,
1) a benzoylurea compound (I) selected from the group consisting of flufenoxuron and teflubenzuron;
2) at least one insecticidal compound (II) selected from the group consisting of acetamiprid, clothianidin, cycloxaprid, imidacloprid, nitenpyram, thiacloprid, thiamethoxam, and 1-[(6-chloro-3-pyridyl)methyl]-7-methyl-8-nitro-5-propoxy-3,5,6,7-tetrahydro-2H-imidazo[1,2-a]pyridine, and
3) one or two compounds (III) selected from the group of compounds
IIIA: azoxystrobin, dimoxystrobin, fluoxastrobin, kresoxim-methyl, picoxystrobin, pyraclostrobin, trifloxystrobin and pyribencarb and/or;
IIIB: bixafen, boscalid and fluxapyroxad;
in a synergistically effective amount.

18. The pesticidal composition according to claim 17 wherein the
compound (I) is teflubenzuron;
compound (II) is clothanidine or thiamethoxam and
compound (III) is pyraclostrobin and/or fluxapyroxad.

19. The pesticidal composition according to claim 17 wherein the
compound (I) is flufenoxuron;
compound (II) is clothanidine, imidacloprid or thiamethoxam and
compound (III) is pyraclostrobin and/or fluxapyroxad.

20. The pesticidal composition according to claim 17 wherein the compound (II) is thiamethoxam and the compounds (III) are pyraclostrobin and fluxapyroxad.

21. The pesticidal composition according to claim 17, comprising the compounds (I), (II), and compound (III) in weight ratio of
compounds (I) to (II) from 100:1 to 1:100;
compounds (II) to (III) from 100:1 to 1:100 and
compounds (I) to (III) from 100:1 to 1:100.

22. A process for preparing the pesticidal composition according to claim 17, said process comprising the step of mixing the compounds (I), (II), and (III).

23. A process for preparing the pesticidal composition according to claim 17, said process comprising the step of applying to the locus the compounds (I), (II) and (III) simultaneously, that is jointly or separately, or in succession.

24. A method for controlling invertebrate pests which method comprises treating the pests, their food supply, their habitat or their breeding ground or a plant, seed, soil, area, material or environment in which the pests are growing or may grow, or the material, plant, seeds, soils, surfaces or spaces to be protected from pest attack or infestation with a synergistically effective amount of a composition as defined in claim 17.

25. A method for treating and/or protecting plants from attack or infestation pests comprising contacting a plant, or soil or water in which the plant is growing, with a composition as defined in claim 17.

26. The method according to claim 25, wherein the plant is a crop plant selected from the group consisting of fruit-bearing plants, vegetables plants, cereals plants, raw material plants, leguminous plants and horticultural plants.

27. The method according to claim 25, wherein the plant is a crop plant selected from the group consisting of fruit-bearing plants, potato, tomato, rice, cereals, corn, soybeans, drybeans, cotton, vegetables, coffee, sugar cane and horticultural plants.

28. A method according to claim 25 wherein the composition comprising the compounds (I), (II) and (III) is applied as foliar application.

29. A method of protection of plant propagation material and/or the plant which grow therefrom, which method comprises treating the plant propagation material with a composition as defined in claim 17.

30. The method according to claim 25 wherein the composition as defined in claim 17 is applied in an amount from 5 to 500 g per hectar for each individual compound.

31. The method according to claim 25 wherein the compounds (I), (II) and eventually (III) as defined in claim 17 is applied simultaneously, that is jointly or separately, or in succession.
